(19) United States
(12) Patent Application Publication
(10) Pub. No.: US 2009/0048408 A1
(43) Pub. Date: Feb. 19, 2009

(54) CATALYST COMPRISING HETEROLEPTIC ALUMINUM AND COBALT COMPOUNDS AND A METHOD OF PREPARING POLYBUTADIENE USING THE SAME

(76) Inventors: Gwanghoon Kwag, Daejeon (KR); Pilsung Kim, Daejeon (KR); Seung Hwon Lee, Daejeon (KR); Hyung Kyu Choi, Daejeon (KR)

Correspondence Address: FROMMER LAWRENCE & HAUG LLP, 745 FIFTH AVENUE, NEW YORK, NY, 10151, US

(21) Appl. No.: 12/187,420

(22) Filed: Aug. 7, 2008

(30) Foreign Application Priority Data
Aug. 13, 2007 (KR) 10-2007-0081365

(51) Int. Cl. C08F 4/602

(52) U.S. Cl. 526/163; 502/117

(57) ABSTRACT

The present invention relates to a novel catalyst for diene polymerization comprising a heteroleptic single-molecule aluminum compound and a cobalt compound having a carboxyl group with a predetermined proportion and a method for preparing polybutadiene from 1,3-butadiene using a catalyst for diene polymerization.

The novel catalyst of the present invention, which comprises a heteroleptic single-molecule aluminum compound with a huge stereostructure and a cobalt compound, has a stabilized catalytic active site without the need of adding a special material for controlling the activity of cobalt, such as water, phenol, alcohol, and phosphorus compound, and has good activity without a catalyst aging process since the reduction of cobalt is minimized. Consequently, the catalyst may be used to polymerize 1,3-butadiene to obtain polybutadienes having cis and trans structures with good yield and narrow molecular weight distribution.

### CROSS-REFERENCE TO RELATED APPLICATION

This application claims priority under 35 U.S.C. §119(a) of Korean Patent Application No. 10-2007-0081365, filed on Aug. 13, 2007, the entire disclosure of which is hereby incorporated by reference.

### TECHNICAL FIELD

The present invention relates to a novel catalyst for diene polymerization comprising a heteroleptic single-molecule aluminum compound and a cobalt compound having a carboxyl group and a method for preparing polybutadiene from 1,3-butadiene using a catalyst for diene polymerization.

### BACKGROUND ART

In general, the structure of polybutadiene varies greatly depending on the additives added in the catalyst used for its preparation. More specifically, U.S. Pat. No. 3,498,963 discloses that the microstructure of polybutadiene largely depends upon the water content and the amount of additives such as phosphorus compound contained in the cobalt catalyst. According to U.S. Pat. No. 4,579,920, 1,2-vinylpolydiene with high stereoregularity can be obtained from the polymerization of butadiene using a catalyst comprising a cobalt salt of carboxylic acid, carbon disulfide and an organo alkali metal compound. Another method of preparing polybutadiene using cobalt carboxylate is disclosed in U.S. Pat. No. 5,733,835, in which butadiene is contacted with a cobalt catalyst in liquid phase. Here, the catalyst used is a mixture of a cobalt salt of carboxylic acid, an organometallic compound, alcohol, etc.

According to Japanese Patent No. 2007-31568, 1,4-cis-polybutadiene can be prepared using a cobalt compound and an aluminum compound. This patent also discloses that 1,2-vinylpolybutadiene can be polymerized by adding carbon disulfide to the catalyst system.

U.S. Pat. No. 6,617,406 discloses a method for polymerizing trans-1,4-cis-polybutadiene from 1,3-butadiene using a catalyst comprising cobalt carboxylate, alkylphenol and organoaluminum.

### DISCLOSURE

### Technical Problem

As described above, in the conventional methods of preparing polybutadiene, polar molecules such as water, phenol, carbon disulfide, etc., are used to control the active site or activity of the cobalt compound. In addition, the aluminum compound is not a single-molecule compound but, in many cases, an oligomer compound. Specifically, alkylaluminum compounds such as AlEt₂Cl, Al₂Cl₃Et₃, AlEt₃, etc., can easily form oligomers by chlorine or carbon bridges to bind aluminum atoms and accelerate the coagulation of catalysts. Cobalt is easily reduced in the presence of an alkylaluminum compound, which results in low activity and a relatively broad molecular weight distribution from low to high molecular weight.

Therefore, an object of the present invention is to provide a catalyst for preparing polybutadiene with superior activity and stability without requiring any additional additives for controlling active sites or activities.

### Technical Solution

The present invention relates to a catalyst for diene polymerization comprising 1) at least one compound selected from the group comprising a trivalent single-molecule aluminum compound represented by the formula (1) below, a tetravalent single-molecule aluminum compound represented by the formula (2) below, a pentavalent single-molecule aluminum compound represented by the formula (3) below and a mixture thereof; and 2) a cobalt compound having a carboxyl group,

wherein the molar ratio between the aluminum atoms and the cobalt atoms is in the range of from 1:1 to 1:20:

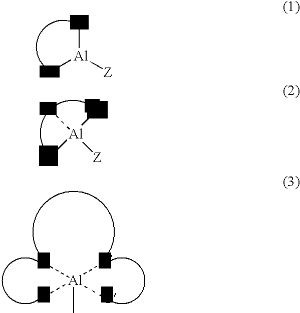

wherein X, X′, Y and Y′ are respectively oxygen, nitrogen, phosphorus, sulfur, alkoxy, phenoxy, carboxyl, alkylsiloxy, allylsiloxy, halogen-substituted alkoxy or halogen-substituted phenoxy and Z is hydrogen, C₁-C₁₀ alkyl, C₁-C₁₀ aryl or halogen.

The present invention further relates to a method of preparing polybutadiene by polymerizing 1,3-butadiene in a nonpolar solvent in the presence of a catalyst for diene polymerization.

### ADVANTAGEOUS EFFECTS

The novel catalyst of the present invention, which comprises a heteroleptic single-molecule aluminum compound with a huge stereostructure and a cobalt compound, has a stabilized active site not necessitating addition of any special chemicals for controlling the activity of cobalt, such as water, phenol, alcohol, and a phosphorus compound, and has good activity without aging of a catalyst since the reduction of cobalt can be minimized. Consequently, the catalyst may be used to polymerize 1,3-butadiene to obtain polybutadienes having cis and trans structures with good yield and narrow molecular weight distribution.

### BEST MODE

The present invention relates to a diene polymerization catalyst, more particularly to a Ziegler-Natta catalyst comprising a heteroleptic single-molecule aluminum compound and a cobalt compound having a carboxyl group.

With a huge stereostructure and a weak reducing power, the heteroleptic single-molecule aluminum compound of the present invention can maintain a stabilized oxidation state of cobalt and protects the active site from the external environment. Further, the adoption of the single-molecule aluminum compound solves the problem caused by the conventional oligomer type aluminum compounds, including coagulation of catalysts, and pyrophoricity.

As the heteroleptic single-molecule aluminum compound, trivalent to hexavalent compounds with an alkyl or halogen group may be used. Preferably, a trivalent or tetravalent single-molecule aluminum compound, which is easy to prepare and has a planar structure; or a pentavalent single-molecule aluminum compound, which has a huge stereostructure, enables various coordinating ligands and a stable ring structure may be used.

Specifically, as a trivalent single-molecule aluminum compound, a compound selected from the group consisting of chloro-2-ethylhexanoxyethylaluminum, chloro-bis(2-ethylhexanoxy)aluminum, ethyl-bis(2-ethylhexanoxy)aluminum, chloro-bis(4-dodecylphenoxy)aluminum, ethyl-bis(4-dodecylphenoxy)aluminum, chloro-bis(4-octylphenoxy)aluminum, ethyl-bis(4-octylphenoxy)aluminum, chloro-2,4,6-tri-t-butylphenoxyethylaluminum, chloro-bis(2,4,6-tri-t-butylphenoxy)aluminum, ethyl-bis(2,4,6-tri-t-butylphenoxy)aluminum, chloropentafluorophenoxyethylaluminum, dipentafluorophenoxyethylaluminum, chloropentachlorophenoxyethylaluminum, dipentachlorophenoxyethylaluminum, chloropentabromophenoxyethylaluminum, dipentabromophenoxyethylaluminum, chloropentaiodophenoxyethylaluminum, dipentaiodophenoxyethylaluminum, ethylpentafluorophenoxypentachlorophenoxyaluminum, ethylpentabromophenoxypentachlorophenoxyaluminum, ethylpentafluorophenoxypentabromophenoxyaluminum, chloropentafluorophenoxypentachlorophenoxyaluminum, chloropentabromophenoxypentachlorophenoxyaluminum and chloropentafluorophenoxypentabromophenoxyaluminum or a mixture thereof may be used.

Specifically, as a tetravalent single-molecule aluminum compound, a compound selected from the group consisting of methylamino-N,N-bis(2-methylene-4,6-dimethylphenoxy)ethylaluminum, butylamino-N,N-bis(2-methylene-4,6-dimethylphenoxy)ethylaluminum, methylamino-N,N-bis(2-methylene-4,6-dimethylphenoxy)chloroaluminum, butylamino-N,N-bis(2-methylene-4,6-dimethylphenoxy)chloroaluminum, ethylamino-N,N-bis(2-methylene-4-methyl-6-t-butylphenoxy)ethylaluminum, butylamino-N,N-bis(2-methylene-4-methyl-6-t-butylphenoxy)ethylaluminum, methylamino-N,N-bis(2-methylene-4-methyl-6-t-butylphenoxy)chloroaluminum and butylamino-N,N-bis(2-methylene-4-methyl-6-t-butylphenoxy)chloroaluminum or a mixture thereof may be used.

Specifically, as a pentavalent single-molecule aluminum compound, a compound having a hemicyclic structure selected from the group consisting of ethyl-2,2′-ethylidene-bis(4,6-dibutylphenoxy)aluminum, chloro-2,2′-ethylidene-bis(4,6-dibutylphenoxy)aluminum, ethyl-3,3′-(ethylenedioxy)diphenoxyaluminum, chloro-3,3′-(ethylenedioxy)diphenoxyaluminum, ethyl-1,4′-dibenzyloxy-2,3-butanedioxyaluminum, 1,4′-dibenzyloxy-2,3-butanedioxyaluminum, chlorodiaminocyclohexane-biphenol-salenaluminum, chloroethyldiaminocyclohexane-biphenol-salenaluminum, chlorodiaminocyclohexane-binaphthol-salenaluminum, ethyldiaminocyclohexane-binaphthol-salenaluminum, chloroalumino-1,3-cyclohexanediimine-N,N′-bis(3,5-di-t-butylsalicylidine)aluminum, ethylalumino-1,3-cyclohexanediimine-N,N′-bis(3,5-di-t-butylsalicylidine)aluminum, ethylaluminotetraphenylporphyrin, ethylaluminophthalocynine, ethylaluminonaphthalocynine, ethylaluminotetraphenylporphyrin, ethylaluminophthalocynine, ethylaluminonaphthalocynine, aluminotetraphenylporphyrin chloride, chloroaluminophthalocynine and chloroaluminonaphthalocynine or a mixture thereof may be used.

And, as a cobalt compound, a cobalt compound having a carboxyl group, which is highly soluble in a nonpolar solvent, specifically one selected from the group consisting of cobalt versatate, cobalt octoate and cobalt naphthenate or a mixture thereof may be used.

In a catalyst for diene polymerization, the molar ratio between the aluminum atoms and the cobalt atoms is in the range of from 1:1 to 1:20, preferably from 1:2 to 1:5. If the aluminum compound is used less than 1 mol per 1 mol of the cobalt compound, polymerization yield will decrease because of insufficient activity. In contrast, if it is used more than 20 mol, the catalytic activity will decrease due to excessive reduction. Thus, it is recommended that the above-mentioned range be maintained.

The present invention also relates to a method of preparing polybutadiene by polymerizing 1,3-butadiene in the presence of a catalyst for diene polymerization. Here, the polymerization can be performed by using a commonly used method. Solution polymerization is preferred, but the present invention is not particularly limited thereto.

The polymerization is performed using a nonpolar solvent from which oxygen and water have been removed. Specifically, a compound selected from the group consisting of butane, pentane, hexane, isopentane, heptane, octane, isooctane, cyclopentane, methylcyclopentane, cyclohexane, methylcyclohexane, ethylcyclohexane, benzene, toluene, ethylbenzene and xylene or a mixture thereof may be used.

The weight of the polymerization solvent used is 3-10 times the weight of the monomer. If its weight is less than 3 times, the polymer solution will become too viscous to be transferred. In contrast, if its weight is more than 10 times, the polymerization reaction will proceed slowly. Hence, it is recommended that the above-mentioned range be maintained.

Since the aluminum compound stabilizes the active site of cobalt and hardly experiences any reduction, it is preferably used without aging.

The catalyst for diene polymerization is used in the amount from 1×10⁻⁵ to 1×10⁻³ mol per 100 g of the monomer. If it is used less than 1×10⁻⁵ mol, large-molecular-weight compounds will be formed because the reaction shall proceed slowly. In contrast, if it is used more than 1×10⁻³ mol, low-molecular-weight compounds will be formed and the reaction will proceed excessively. Hence, it is recommended that the above-mentioned range be maintained.

The polymerization reaction may be preformed under an inert gas atmosphere, specifically under high-purity nitrogen atmosphere, at −20 to 150° C., preferably at 40 to 100° C., for 30 min to 7 hrs, preferably for 30 min to 3 hrs. If the polymerization temperature is below −20° C., the polymerization reaction will occur slowly. In contrast, if it exceeds 150° C., the control of the polymerization rate will become difficult and gelation may occur. Hence, it is recommended that the above-mentioned range be maintained. Further, if the polymerization is conducted for less than 30 min, the yield will be low. In contrast, if it is conducted for more than 7 hrs, viscosity increases because of extended residence of polymers, resulting in the difficulty of transfer. Hence, it is recommended that the above-mentioned range be maintained.

The polybutadiene prepared by the above method has a weight-average molecular weight in the range of from 100,000 to 3,000,000, a Mooney viscosity (ML₁₊₄, 100° C.) in the range of from 10 to 100, a controlled cis and trans structure and a narrow molecular weight distribution.

The following examples describe embodiments of the present invention. Other embodiments within the scope of the claims herein will be apparent to those skilled in the art from consideration of the specification or practice of the invention as disclosed herein. It is intended that the specification, together with the examples, to be considered exemplary only, with the scope and spirit of the invention being indicated by the claims, which follow the examples.

### EXAMPLE 1

Cobalt octoate (1.0% cyclohexane solution), ethylsalenaluminum (EtAl-salen) and chlorosalenaluminum (ClAl-salen) were used as Ziegler-Natta catalyst and 3.5×10⁻⁵ mol of cobalt catalyst was used per 100 g of monomer. Polymerization was performed as follows. Nitrogen gas was sufficiently flown in to a 1-L high-pressure glass reactor. Then, after successively adding cobalt octoate and ethylsalenaluminum and chlorosalenaluminum to cyclohexane, with the molar ratio of 1:10:5, 1,3-butadiene (100 g) was added as monomer. Reaction was carried out at 40° C. for 2 hrs.

The weight of the polymerization solvent is 5 times the weight of the monomer. After the above reaction, 0.5 g of 2,6-di-t-butyl-p-cresol was added as antioxidant and 0.3 g of polyoxyethylene phosphate and 10 g of ethanol were added to terminate the reaction.

### EXAMPLE 2

Polybutadiene was prepared same as in Example 1, except for using a catalyst comprising cobalt octoate/EtAlQ₂/ClAlQ₂, as listed in Table 1.

### EXAMPLE 3

Polybutadiene was prepared same as in Example 1, except for using a catalyst comprising cobalt octoate/EtAlPh/ClAlPh, as listed in Table 1.

### EXAMPLE 4

Polybutadiene was prepared same as in Example 1, except for using a catalyst comprising cobalt octoate/EtAlPc/ClAlPc, as listed in Table 1.

### EXAMPLE 5

Polybutadiene was prepared same as in Example 1, except for using a catalyst comprising cobalt octoate/EtAlBHT₂/ClAlBHT₂, as listed in Table 1.

### EXAMPLE 6

Polybutadiene was prepared same as in Example 1, except for using a catalyst comprising cobalt octoate/EtAlBPh/ClAlBPh, as listed in Table 1.

### EXAMPLE 7

Polybutadiene was prepared same as in Example 1, except for using a catalyst comprising cobalt octoate/EtAl-salen, as listed in Table 1.

### EXAMPLE 8

Polybutadiene was prepared same as in Example 1, except for using a catalyst comprising cobalt octoate/EtAlQ2, as listed in Table 1.

### EXAMPLE 9

Polybutadiene was prepared same as in Example 1, except for using a catalyst comprising cobalt octoate/EtAlPh, as listed in Table 1.

### EXAMPLE 10

Polybutadiene was prepared same as in Example 1, except for using a catalyst comprising cobalt octoate/EtAlPc, as listed in Table 1.

### EXAMPLE 11

Polybutadiene was prepared same as in Example 1, except for using a catalyst comprising cobalt octoate/EtAlBHT₂, as listed in Table 1.

### EXAMPLE 12

Polybutadiene was prepared same as in Example 1, except for using a catalyst comprising cobalt octoate/EtAlPFP2, as listed in Table 1.

### EXAMPLE 13

Polybutadiene was prepared same as in Example 1, except for using a catalyst comprising cobalt octoate/EtAl(BHT)(PFP), as listed in Table 1.

### EXAMPLE 14

Polybutadiene was prepared same as in Example 1, except for using a catalyst comprising cobalt octoate/EtAlBPh, as listed in Table 1.

### EXAMPLE 15

Polybutadiene was prepared same as in Example 1, except for using a catalyst comprising cobalt octoate/EBDPA, as listed in Table 1.

### COMPARATIVE EXAMPLE 1

Polymerization was performed according to a conventional method, using cobalt octoate/tripentafluorophenylphosphine/TEA/H₂O as Ziegler-Natta catalyst and using 3.0×10⁻⁴ mol cobalt catalyst per 100 g of butadiene. The reaction catalyst was aged by sufficiently flowing in nitrogen to a rubber-sealed, 100-mL round flask and successively adding TEA and H₂O. The catalyst was aged at 20° C. for 10 min before using in the polymerization. The polymerization was performed as follows. Nitrogen was sufficiently flown in to a 1-L high-pressure reactor. Then, after adding a cyclohexane polymerization solvent, the aging solution of TEA and H₂O, cobalt octoate (1 wt % cyclohexane), tripentafluorophenylphosphine (1 wt %, dichloromethane solution) and 1,3-butadiene (100 g) were reacted at 40° C. for 2 hrs.

The weight of the polymerization solvent used was 5 times the weight of the monomer. Following the above reaction, 0.5 g of 2,6-di-t-butyl-p-cresol was added as antioxidant and 0.2 g of polyoxyethylene phosphate and 10 g of ethanol were added to terminate the reaction.

### COMPARATIVE EXAMPLE 2

Polybutadiene was prepared same as in Comparative Example 1, except for using a catalyst comprising cobalt octoate/triphenylphosphine/TEA/H₂O, as listed in Table 1.

### COMPARATIVE EXAMPLE 3

Polybutadiene was prepared same as in Comparative Example 1, except for using a catalyst comprising cobalt octoate/DEAC/H₂O, as listed in Table 1.

### COMPARATIVE EXAMPLE 4

Polybutadiene was prepared same as in Comparative Example 1, except for using a catalyst comprising cobalt octoate/dodecylphenol/TEA, as listed in Table 1.

### COMPARATIVE EXAMPLE 5

Polybutadiene was prepared same as in Comparative Example 1, except for using a catalyst comprising cobalt octoate/TEA/H₂O/CS₂, as listed in Table 1.

### COMPARATIVE EXAMPLE 6

Polybutadiene was prepared same as in Comparative Example 1, except for using a catalyst comprising cobalt octoate/TEA, as listed in Table 1.

### COMPARATIVE EXAMPLE 7

Polybutadiene was prepared same as in Comparative Example 1, except for using a catalyst comprising cobalt octoate/TEA/DEAC, as listed in Table 1.

Yield, weight-average molecular weight, molecular weight distribution, polybutadiene structure (proportions of 1,4-cis, 1,4-trans and 1,2-vinyl) of the polybutadienes prepared in Examples 1 to 14 and Comparative Examples 1 to 7 were measured. The result is presented in Table 2. The 1,4-cis content was measured by the Morero method [Chim. Indust., Vol. 41, p. 758 (1959)].

TABLE 1

| | | Co conc. | |
|---|---|---|---|
| | Catalyst composition | (mol) | Molar ratio |
| Ex. 1 | Cobalt octoate/EtAl-salen/ClAl-salen | 3.5 × 10⁻⁵ | Co/Cl/Al = 1/10/5 |
| Ex. 2 | Cobalt octoate/EtAlQ₂/ClAlQ₂ | 3.5 × 10⁻⁵ | Co/Cl/Al = 1/10/5 |
| Ex. 3 | Cobalt octoate/EtAlPh/ClAlPh | 3.5 × 10⁻⁵ | Co/Cl/Al = 1/10/5 |
| Ex. 4 | Cobalt octoate/EtAlPc/ClAlPc | 3.5 × 10⁻⁵ | Co/Cl/Al = 1/10/5 |
| Ex. 5 | Cobalt octoate/EtAlBHT₂/ClAlBHT₂ | 3.5 × 10⁻⁵ | Co/Cl/Al = 1/10/5 |
| Ex. 6 | Cobalt octoate/EtAlBPh/ClAlBPh | 3.5 × 10⁻⁵ | Co/Cl/Al = 1/10/5 |
| Ex. 7 | Cobalt octoate/EtAl-salen | 7.0 × 10⁻⁵ | Co/Cl/Al = 1/10/5 |
| Ex. 8 | Cobalt octoate/EtAlQ₂ | 7.0 × 10⁻⁵ | Co/Cl/Al = 1/0/5 |
| Ex. 9 | Cobalt octoate/EtAlPh | 7.0 × 10⁻⁵ | Co/Cl/Al = 1/0/5 |
| Ex. 10 | Cobalt octoate/EtAlPc | 7.0 × 10⁻⁵ | Co/Cl/Al = 1/0/5 |
| Ex. 11 | Cobalt octoate/EtAlBHT₂ | 7.0 × 10⁻⁵ | Co/Cl/Al = 1/0/5 |
| Ex. 12 | Cobalt octoate/EtAlPFP₂ | 7.0 × 10⁻⁵ | Co/Cl/Al = 1/0/5 |
| Ex. 13 | Cobalt octoate/EtAl(BHT)(PFP) | 7.0 × 10⁻⁵ | Co/Cl/Al = 1/0/5 |
| Ex. 14 | Cobalt octoate/EtAlBPh | 7.0 × 10⁻⁵ | Co/Cl/Al = 1/0/5 |
| Ex. 15 | Cobalt octoate/EBDPA | 7.0 × 10⁻⁵ | Co/Cl/Al = 1/0/5 |
| Comp. | Cobalt | 3.0 × 10⁻⁴ | Co/P/Al/H₂O = 1/2/50/50 |
| Ex. 1 | octoate/tripentafluorophenylphosphine/TEA/ | | |
| | H₂O | | |
| Comp. | Cobalt octoate/triphenylphosphine/TEA/H₂O | 3.0 × 10⁻⁴ | Co/P/Al/H₂O = 1/2/50/50 |
| Ex. 2 | | | |
| Comp. | Cobalt octoate/DEAC/H₂O | 2.8 × 10⁻⁴ | Co/Al/H₂O = 1/5/1 |
| Ex. 3 | | | |
| Comp. | Cobalt octoate/dodecylphenol/TEA | 1.4 × 10⁻⁴ | Co/Al/Ph = 1/6/15 |
| Ex. 4 | | | |
| Comp. | Cobalt octoate/TEA/H₂O/CS₂ | 2.8 × 10⁻⁴ | Co/Al/H₂O/S = 1/10/1.5/1 |
| Ex. 5 | | | |
| Comp. | Cobalt octoate/TEA | 3.0 × 10⁻⁴ | Co/Al = 1/5 |
| Ex. 6 | | | |
| Comp. | Cobalt octoate/TEA/DEAC | 3.0 × 10⁻⁴ | Co/Cl/Al = 1/10/5 |
| Ex. 7 | | | |

1) Cobalt octoate = Co(octoate)₂;
2) chloroaluminumsalen (ClAl-salen) = chloroalumino-1,3-cyclohexanediimine-N,N′-bis(3,5-di-t-butylsalicylidine);
3) ethylaluminumsalen (EtAl-salen) = ethylalumino-1,3-cyclohexandiimine-N,N′-bis(3,5-di-t-butylsalicylidine);
4) Q = 8-hydroxyquinoline;
5) Ph = 2,2′-ethylidene-bis(4,6-di-ter-butylphenol);
6) Pc = octabutoxyphthalocyanine;
7) BHT = di-t-butylmethylphenol;
8) BPh = methylamino-N,N-bis(2-methylene-4,6-dimethylphenol);
9) PFP = pentafluorophenol;
10) DEAC = diethylaluminum chloride;
11) TEA = triethylaluminum (Et₃Al);
12) EBDPA = ethyl-bis(4-dodecylphenoxy)aluminum

TABLE 2

| | | Activity | | | | | |
|---|---|---|---|---|---|---|---|
| | | (g/Co | Microstructure | | | | |
| | Yield (%) | mol) | cis (%) | vinyl (%) | trans (%) | M_{w} | MWD |
| Ex. 1 | 75 | 2.1 × 10⁶ | 96.4 | 2.8 | 0.8 | 392000 | 2.01 |
| Ex. 2 | 82 | 2.3 × 10⁶ | 96.0 | 2.7 | 1.3 | 404000 | 1.95 |
| Ex. 3 | 92 | 2.6 × 10⁶ | 96.4 | 2.2 | 1.4 | 259000 | 2.23 |
| Ex. 4 | 89 | 2.5 × 10⁶ | 95.9 | 2.5 | 1.6 | 309000 | 2.11 |
| Ex. 5 | 95 | 2.7 × 10⁶ | 96.5 | 2.5 | 1.5 | 278000 | 2.04 |
| Ex. 6 | 87 | 2.5 × 10⁶ | 95.1 | 2.7 | 2.2 | 459000 | 2.15 |
| Ex. 7 | 75 | 1.1 × 10⁶ | 0 | 15 | 85 | 303000 | 2.19 |
| Ex. 8 | 86 | 1.2 × 10⁶ | 0 | 14 | 86 | 201000 | 2.21 |
| Ex. 9 | 79 | 1.1 × 10⁶ | 0 | 15 | 85 | 279000 | 2.19 |
| Ex. 10 | 81 | 1.2 × 10⁶ | 0 | 15 | 85 | 291000 | 2.15 |
| Ex. 11 | 92 | 1.3 × 10⁶ | 0 | 14 | 86 | 159000 | 2.09 |
| Ex. 12 | 73 | 1.1 × 10⁶ | 0 | 16 | 84 | 457000 | 2.29 |
| Ex. 13 | 84 | 1.2 × 10⁶ | 0 | 15 | 85 | 395000 | 2.20 |
| Ex. 14 | 78 | 1.1 × 10⁶ | 0 | 14 | 86 | 510000 | 2.41 |
| Ex. 15 | 85 | 1.2 × 10⁶ | 0 | 17 | 83 | 417000 | 2.35 |
| Comp. | 25 | 8.3 × 10⁴ | 95.4 | 3.0 | 1.6 | 105000 | 4.21 |
| Ex. 1 | | | | | | | |
| Comp. | 79 | 2.5 × 10⁵ | 4.0 | 96.0 | 0 | 404000 | 4.30 |
| Ex. 2 | | | | | | | |
| Comp. | 49 | 1.8 × 10⁵ | 96.1 | 2.6 | 1.3 | 302000 | 3.66 |
| Ex. 3 | | | | | | | |
| Comp. | 62 | 1.2 × 10⁵ | 0 | 15 | 85 | 325000 | 4.34 |
| Ex. 4 | | | | | | | |
| Comp. | 71 | 1.1 × 10⁵ | 5 | 88 | 7 | 257000 | 3.70 |
| Ex. 5 | | | | | | | |
| Comp. | <5 | 1.7 × 10⁴ | — | — | — | — | — |
| Ex. 6 | | | | | | | |
| Comp. | <10 | 3.3 × 10⁴ | — | — | — | — | — |
| Ex. 7 | | | | | | | |

Yield and activity based on 2 hrs of polymerization
M_{w}: weight-average molecular weight
MWD: molecular weight distribution

As shown in Table 2, the polybutadienes prepared in Examples 1 to 14 using the catalysts comprising the aluminum compound and the cobalt compound in accordance with the present invention were superior in yield and activity compared with those of Comparative Examples 1 to 7, even without the process of activating the catalysts. In addition, it was confirmed that selective preparation of cis and trans structures are possible and a large molecular weight and, at the same time, a narrow molecular weight distribution can be attained.

Although illustrative embodiments of the present invention have been described, it is to be understood that the invention is not limited to those precise embodiments, and that various other changes and modifications may be effected therein by those skilled in the art without departing from the scope and spirit of the invention.

1. A catalyst for diene polymerization comprising at least one compound selected from the group consisting of a trivalent single-molecule aluminum compound represented by the formula (1) below, a tetravalent single-molecule aluminum compound represented by the formula (2) below, a pentavalent single-molecule aluminum compound represented by the formula (3) below and a mixture thereof; and a cobalt compound having a carboxyl group,
wherein the molar ratio between the aluminum atoms and the cobalt atoms is in the range of from 1:1 to 1:20: 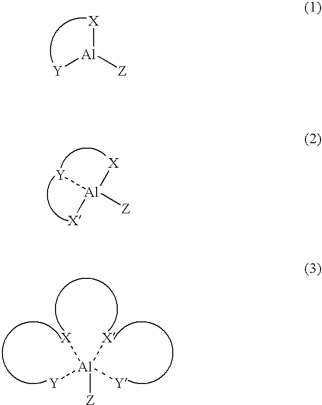
wherein X, X′, Y and Y′ are respecitvely oxygen, nitrogen, phosphorus, sulfur, alkoxy, phenoxy, carboxyl, alkylsiloxy, allylsiloxy, halogen-substituted alkoxy or halogen-substituted phenoxy and Z is hydrogen, C₁-C₁₀ alkyl, C₁-C₁₀ aryl or halogen.

2. The catalyst for diene polymerization according to claim 1, wherein the trivalent single-molecule aluminum compound represented by the formula (1) is a compound selected from the group consisting of chloro-bis(2-ethylhexanoxy)aluminum, ethyl-bis(2-ethylhexanoxy)aluminum, chloro-bis(4-dodecylphenoxy)aluminum, ethyl-bis(4-dodecylphenoxy)aluminum, chloro-bis(4-octylphenoxy)aluminum, ethyl-bis(4-octylphenoxy)aluminum, chloro-2,4,6-tri-t-butylphenoxyethylaluminum, chloro-bis(2,4,6-tri-t-butylphenoxy)aluminum, ethyl-bis (2,4,6-tri-t-butylphenoxy)aluminum, chloropentafluorophenoxyethylaluminum, dipentafluorophenoxyethylaluminum, chloropentachlorophenoxyethylaluminum, dipentachlorophenoxyethylaluminum, chloropentabromophenoxyethylaluminum, dipentabromophenoxyethylaluminum, chloropentaiodophenoxyethylaluminum, dipentaiodophenoxyethylaluminum, ethylpentafluorophenoxypentachlorophenoxyaluminum, ethylpentabromophenoxypentachlorophenoxyaluminum, ethylpentafluorophenoxypentabromophenoxyaluminum, chloropentafluorophenoxypentachlorophenoxyaluminum, chloropentabromophenoxypentachlorophenoxyaluminum and chloropentafluorophenoxypentabromophenoxyaluminum or a mixture thereof.

3. The catalyst for diene polymerization according to claim 1, wherein the tetravalent single-molecule aluminum compound is a compound selected from the group consisting of methylamino-N,N-bis(2-methylene-4,6-dimethylphenoxy)ethylaluminum, butylamino-N,N-bis(2-methylene-4,6-dimethylphenoxy)ethylaluminum, methylamino-N,N-bis(2-methylene-4,6-dimethylphenoxy)chloroaluminum, butylamino-N,N-bis(2-methylene-4,6-dimethylphenoxy)chloroaluminum, ethylamino-N,N-bis(2-methylene-4-methyl-6-t-butylphenoxy)ethylaluminum, butylamino-N,N-bis(2-methylene-4-methyl-6-t-butylphenoxy)ethylaluminum, methylamino-N,N-bis(2-methylene-4-methyl-6-t-butylphenoxy)chloroaluminum and butylamino-N,N-bis(2-methylene-4-methyl-6-t-butylphenoxy)chloroaluminum or a mixture thereof.

4. The catalyst for diene polymerization according to claim 1, wherein the pentavalent single-molecule aluminum compound is a compound selected from the group consisting of ethyl-2,2′-ethylidene-bis(4,6-dibutylphenoxy)aluminum, chloro-2,2′-ethylidene-bis(4,6-dibutylphenoxy)aluminum, ethyl-3,3′-(ethylenedioxy)diphenoxyaluminum, chloro-3,3′-(ethylenedioxy)diphenoxyaluminum, ethyl-1,4′-dibenzyloxy-2,3-butanedioxyaluminum, chloro-1,4′-dibenzyloxy-2,3-butanedioxyaluminum, chlorodiaminocyclohexane-biphenol-salenaluminum, ethyldiaminocyclohexane-biphenol-salenaluminum, chlorodiaminocyclohexane-binaphthol-salenaluminum and ethyldiaminocyclohexane-binaphthol-salenaluminum, chloroalumino-1,3-cyclohexanediimine-N,N′-bis(3,5-di-t-butylsalicylidine)aluminum ethylalumino-1,3-cyclohexanediimine-N,N′-bis(3,5-di-t-butylsalicylidine)aluminum, ethylaluminotetraphenylporphyrin, ethylaluminophthalocynine, ethylaluminonaphthalocynine, ethylaluminotetraphenylporphyrin, ethylaluminophthalocynine, ethylaluminonaphthalocynine, chloroaluminotetraphenylporphyrin, chloroaluminophthalocynine and chloroaluminonaphthalocynine or a mixture thereof.

5. The catalyst for diene polymerization according to claim 1, wherein the cobalt compound having a carboxyl group is a compound selected from the group consisting of cobalt versatate, cobalt octoate and cobalt naphthenate or a mixture thereof.

6. A method for preparing polybutadiene by polymerizing 1,3-butadiene in a nonpolar solvent in the presence of the catalyst for diene polymerization according to claim 1.

7. The method for preparing polybutadiene according to claim 6, wherein the nonpolar solvent is selected from the group consisting of butane, pentane, hexane, isopentane, heptane, octane, isooctane, cyclopentane, methylcyclopentane, cyclohexane, methylcyclohexane, ethylcyclohexane, benzene, toluene, ethylbenzene and xylene or a mixture thereof.

8. The method for preparing polybutadiene according to claim 6, wherein the polymerization reaction is performed at −20 to 150° C. for 30 min to 7 hrs.

9. The method for preparing polybutadiene according to claim 6, wherein the catalyst is used in the amount of 1×10⁻⁵ to 1×10⁻³ mol per 100 g of the butadiene monomer.

10. The method for preparing polybutadiene according to claim 6, wherein the polybutadiene has a weight-average molecular weight in the range of from 100,000 to 3,000,000 and a Mooney viscosity (ML₁₊₄, 100° C.) in the range of from 10 to 100.

11. A method for preparing polybutadiene by polymerizing 1,3-butadiene in a nonpolar solvent in the presence of the catalyst for diene polymerization according to claim 2.

12. A method for preparing polybutadiene by polymerizing 1,3-butadiene in a nonpolar solvent in the presence of the catalyst for diene polymerization according to claim 3.

13. A method for preparing polybutadiene by polymerizing 1,3-butadiene in a nonpolar solvent in the presence of the catalyst for diene polymerization according to claim 4.

14. A method for preparing polybutadiene by polymerizing 1,3-butadiene in a nonpolar solvent in the presence of the catalyst for diene polymerization according to claim 5.
